(19) United States
(12) Patent Application Publication
(10) Pub. No.: US 2008/0147277 A1
(43) Pub. Date: Jun. 19, 2008

(54) ACTIVE SAFETY SYSTEM

(75) Inventors: Jianbo Lu, Livonia, MI (US); Jeffrey Rupp, Ann Arbor, MI (US); Douglas S. Rhode, Farmington Hills, MI (US); Michael Lopez, Dearborn, MI (US); Levasseur Tellis, Southfield, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 11/612,026

(22) Filed: Dec. 18, 2006

(51) Int. Cl. B60R 22/00

(52) U.S. Cl. 701/45; 701/36; 280/735

(57) ABSTRACT

According to one embodiment, an active safety control system for a driver of a vehicle is provided when the vehicle is in a first perturbed state. The system generally includes a plurality of sensors, an actuation system and a controller. The plurality of sensors are operable to generate signals which indicate that the vehicle is in the first perturbed state. The actuation system is adapted to change driving conditions of the vehicle. The controller is configured to selectively control the actuation system in response to the signals without driver intervention to change the driving conditions of the vehicle to regain control of the vehicle after the vehicle has entered the first perturbed state.

### BACKGROUND

1. Technical Field

One or more embodiments of the present invention relate to an active safety system.

2. Background Art

Many conventional safety control systems are directed to detecting and preventing primary collisions based on an initial threat of a collision. Such conventional safety control systems fail to provide detection for secondary collisions in the event the vehicle maintains some degree of speed and velocity and is directed into oncoming objects after the collision. In addition, these conventional safety control systems fail to assess whether the driver is acting in a manner which would enable the driver to regain control of the vehicle after a primary collision. Conventional safety control systems also fail to override the driver's control of the vehicle in the event the driver's controls over the vehicle exposes the vehicle and the driver to additional injury and damage due to secondary collisions.

Accordingly, it would be desirable to implement a total active safety control system that detects and attempts to prevent secondary collisions in the event a primary collision could not be avoided. It would also be desirable to implement an active safety control system that is able to detect when the vehicle is in a state of duress due to road conditions, internal failures associated with the vehicle and a primary collision such that any collateral damage that may be experienced by the driver and vehicle due to an ensuing collision or roll over event may be avoided. If it is not possible to avoid an ensuing collision, then it would be desirable to implement an active control system to orient the vehicle based on speed and direction such that any potential injury to the driver and potential damage to the vehicle may be minimized.

### SUMMARY

According to an embodiment of the present invention, an active safety control system for a driver of a vehicle is provided when the vehicle is in a first perturbed state. The system generally includes a plurality of sensors, an actuation system and a controller. The plurality of sensors are operable to generate signals which indicate that the vehicle is in the first perturbed state. The actuation system is adapted to change driving conditions of the vehicle. The controller is configured to selectively control the actuation system in response to the signals without driver intervention to change the driving conditions of the vehicle and regain control of the vehicle after the vehicle has entered the first perturbed state.

One or more of the embodiments of the present invention generally provide an active safety control system that detects and attempts to prevent secondary collisions in the event a primary collision could not be avoided. In addition, the active safety control system is able to detect when the vehicle is in a first perturbed state and is further able to control the vehicle in such a manner that any ensuing perturbations that may be experienced by the driver is avoided. If it is not possible to avoid any ensuing perturbations, the active safety control system is configured to orient the speed and direction of the vehicle such that any potential injury to the driver and damage to the vehicle is minimized. The active safety control system is further configured to override the driver's control over the vehicle after the vehicle has entered into a first perturbed state in the event the driver's control over the vehicle may lead to injury to the driver and increased damage to the vehicle.

### BRIEF DESCRIPTION OF THE DRAWINGS

FIG. 1 is a block diagram of an active control system;

FIGS. 2a-2b are diagrams illustrating various examples of external perturbations being exerted on a vehicle;

FIG. 3 is a diagram illustrating another of an external perturbation exerted on the vehicle;

FIG. 4 is a diagram illustrating another example of an external perturbation;

FIG. 5 is a diagram illustrating another example of an external perturbation;

FIG. 6 is a diagram illustrating an example of an internal perturbation;

FIG. 7 is a diagram illustrating another example of an internal perturbation;

FIG. 8 is a flow diagram for detecting a first perturbed state due to an internal failure in the vehicle and for preventing a second perturbed state;

FIG. 9 is a flow diagram for detecting a first perturbed state due to a road condition and for preventing the vehicle from entering into a second perturbed state; and

FIG. 10 is a flow diagram for detecting a first perturbed state due to a primary collision and for preventing the vehicle from entering into a second perturbed state.

### DETAILED DESCRIPTION OF EMBODIMENTS

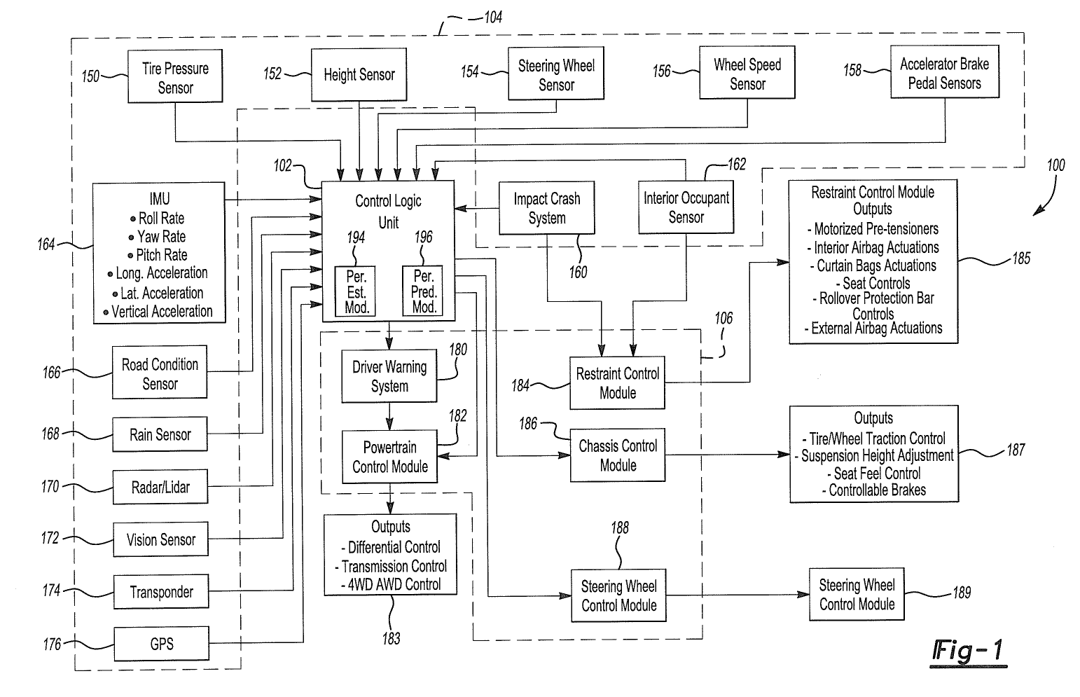

Referring to FIG. 1, a block diagram of an active control safety system 100 is shown in accordance with one embodiment of the present invention. The system 100 includes a controller 102, otherwise referred to as a control logic unit. An actuation system 106 may be controlled by the controller 102. A plurality of sensors 104 are coupled to the controller 102 and the actuation system 106.

The plurality of sensors 104 includes a number of sensors to be adapted for use in an automotive vehicle. The plurality of sensors 104 may include various sensors related to detecting the state of the vehicle, the external surroundings of the vehicle, and/or the condition of internal components within the vehicle.

A tire pressure sensor 150 may be positioned in each wheel of the vehicle. The tire pressure sensor 150 may be configured to detect the amount of pressure in each wheel and transmit the amount of pressure to the controller 102. Tire pressure information may be inferred by the rolling radius of each of the tires. The tire pressure sensor 150 generally sends information related to the amount of tire pressure to the controller 102. The number of tire pressure sensors 150 packaged in the vehicle may be varied to meet the design criteria of a particular implementation.

A height sensor 152 may be positioned within the suspension system of the vehicle. The height sensor 152 may sense the height of the vehicle body from a surface of the road or the suspension displacement (called suspension stroke or suspension height). The height sensor 152 may transmit information which corresponds to the height of the vehicle with respect to the road or the wheel to the controller 102. The number of height sensors 152 implemented in the vehicle may be varied to meet design criteria of a particular implementation.

A steering wheel sensor 154 may be coupled to a shaft of the vehicle steering wheel (not shown). The steering wheel sensor 154 may provide the particular position of the steering wheel. The steering wheel position sensor 154 may also provide information related to the amount of torque that is being applied to the steering wheel by the driver. The steering wheel sensor 154 may generate an absolute position or a relative position of the steering wheel depending on the type of vehicle system being implemented. The steering wheel sensor 154 generates a signal which corresponds to the angle of movement of the driver's hand wheel. The steering wheel sensor 154 senses and transmits information related to the absolute or relative position of the steering wheel shaft, and the amount of torque applied to the steering wheel to the controller 102.

A wheel speed sensor 156 may be positioned proximate to the wheels of the vehicle. In one example, the wheel speed sensor 156 may be positioned at a transmission output shaft of the vehicle. The wheel speed sensor 156 may be implemented as a toothed-wheel type sensor that generates pulses in response to rotational rate of each wheel. For example, the wheel speed sensor 156 may generate a signal based on 8,000 pulses per mile (8 KPPm) in response to the rotational rate of each wheel. In general, the wheel speed sensor 156 may be used to sense and transmit information related to the speed of the vehicle. The wheel speed sensor 156 senses and transmits information related to vehicle speed to the controller 102 and to various modules in the actuation system 106.

An accelerator/brake pedal sensor 158 may sense the amount of actuation of the accelerator pedal and brake pedal of the vehicle. The accelerator/brake pedal sensor 158 may also generate a signal which corresponds to the rate of the movement of the accelerator pedal. The accelerator/brake pedal sensor 158 may also provide information which corresponds to the operation of the brake pedal. The accelerator/brake pedal sensor 158 may provide information as to the amount of brake pedal movement or the rate of brake pedal movement. In general, the accelerator/brake pedal sensor 158 may detect the moment a driver applies the brakes. The accelerator/brake pedal sensor 158 generally senses and transmits information related to the rate of the movement of the accelerator pedal, the amount of brake pedal movement and the moment the driver selects the brakes to the controller 102 and various other modules in the activation system 106.

The plurality of sensors 104 may also include sensors directly coupled to the actuation system 106. An impact crash sensor 160 may be positioned in the vehicle to detect the moment an object collides with the vehicle. The resulting impact due to the collision may be detected by the impact crash sensor 160. The impact crash sensor 160 may sense and transmit information related to the magnitude of impact to the actuation system 106 such that the actuation system 106 may determine whether to deploy various air bags located throughout the vehicle. The impact crash sensor 160 may also provide information related to the magnitude of impact to the controller 102.

An interior occupant sensor 162 may detect the number of occupants who are located in the vehicle and the position of the occupants in the vehicle. The interior occupant sensor 162 may provide information related to the number and position of the occupants in the vehicle to the actuation system 106 such that the actuation system 106 may determine which air bags need to be deployed in the event of a collision.

The plurality of sensors 104 may also include sensors related to detecting various characteristics associated with the external environment of the vehicle. An inertial measuring unit (IMU) sensing unit 164 may be positioned in the vehicle and detect a roll rate of the vehicle, a yaw rate of the vehicle, a pitch rate, a longitudinal acceleration and a latitudinal acceleration of the vehicle. While the IMU sensing unit 164 generally includes a single unit adapted to detect the roll rate, the yaw rate, the pitch rate, the longitudinal acceleration, the latitude acceleration and the vertical acceleration of the vehicle within the same unit, other embodiments may include separated or non-centralized sensors for detecting the various features typically detected by the IMU sensing unit 164. The IMU sensing unit 164 may detect and transmit signals related to the roll rate, the yaw rate, the pitch rate, the longitudinal acceleration, the latitude acceleration and the vertical acceleration to the controller 102.

A road surface condition sensor 166 may be positioned in the vehicle and detect various conditions of the road. The road surface condition sensor 166 may determine if tire traction is reduced because of a particular road surface condition. Reduced tire traction may result in excessive slip and ultimately loss of vehicle control. Reduced traction may be caused by rain, snow, ice, rough road and various other elements. The road surface condition may be communicated to the controller 102 and be used to determine driving perturbations.

A rain sensor 168 may be positioned in the vehicle and work in conjunction with an automatic windshield wiping system (not shown). The rain sensor 168 may measure reflectants of light and generate an output based on the amount of moisture on the windshield. Such information may be used to improve stability control of the vehicle. By detecting the amount of moisture on the window, the automatic windshield system may automatically turn on the wiping system without driver intervention. In addition, upon the detection of rain, the actuation system 106 may apply a relatively small amount of pressure to calipers of the brake to eliminate potential water build up between the brake pad and the brake disk. The rain sensor 168 may provide information related to the amount of moisture on the windshield to the controller 102.

A radar/lidar sensor 170 may detect the speed and direction of another vehicle that may be approaching the vehicle. The radar/lidar sensor 170 may be disposed on various locations of the vehicle. The radar/lidar sensor 170 may transmit information related to the speed and direction of an on-coming vehicle to the controller 102. The radar/lidar sensor 170 may determine the position of obstacles relative to the vehicle. Such information may be used by the controller 102 to determine a safe feasible path for the vehicle. A vision sensor 172 may include one more cameras (not shown) located at predetermined vehicle positions. The vision sensor 172 may provide information related to the position and the direction of the oncoming vehicles to the controller 102.

A transponder 174 may transmit vehicle information to other vehicles and receive information from other vehicles so that a potential crash determination can be made. The transponder 174 may provide the information received from other vehicles to the controller 102. The radar/lidar sensor 170, the vision sensor 172 and the transponder 174 may be used to prepare the vehicle for an imminent collision. In such an example, an air bag controller may pre-arm various air bags in preparation for the impact based on the inputs received by the radar/lidar sensor 170, the vision sensor 172 and the transponder 174.

A global positioning system (GPS) sensor 176 may generate the current position of the vehicle and road geometry information. The GPS sensor 176 may also be used to sense the velocity and direction of the vehicle. The GPS sensor 176 can also provide information related to various road conditions of an upcoming road condition. In one example, the GPS sensor 176 may be implemented as part of the IMU sensing unit 164. The GPS sensor 176 and the IMU sensing unit 164 may be used together to determine the altitude and velocity of the vehicle.

The actuation system 106 generally includes a number of modules configured to control various operations of the vehicle in response to signals generated by the controller 102. The actuation system 106 may also control various operations of the vehicle independent of any control from the controller 102. The actuation system 106 includes a driver warning system 180, which may be configured to provide warning signals to the driver in response to a signal received by the controller 102. Such warnings may include a warning that the tire pressure is too low, one or more of the tires have blown-out, the road is slippery (due to rain, snow, etc.), a suspension system has a failed component at one of the corners, the vehicle is overloaded, the vehicle is departing a lane, a sensor cluster has a failed component, a braking system has failed, the controller 102 has shutdown, or the specific vehicle active control system is activated. The particular type of warning displayed by the driver warning system 180 may be varied to meet the design criteria of a particular implementation. The driver warning system 180 may be configured to present any number of warnings to the user other than those described.

A powertrain control module 182 may be configured to control the acceleration of the vehicle or the velocity of the vehicle in response to a signal received by the controller 102. Non-limiting examples of powertrain control module outputs are described in block 183. The powertrain control module 182 may also cut off power to the engine when needed. The powertrain control module 182 may control a differential in order to generate proper driving torque bias to assist in correcting a path of the vehicle. The powertrain control module 182 may include a transmission module for changing states of the transmission. The transmission module may be adapted to move the vehicle into four-wheel drive and all-wheel drive. The particular functions performed by the powertrain control module 182 may be varied to meet the design criteria of a particular implementation.

In one example, a separate transmission control module (not shown) may be implemented in the system 100. The transmission control module may be controlled by the controller 102 to select various transmission states. In another example, a four-wheel drive module (not shown) may be implemented as a stand alone module and may be configured to receive a signal from the controller 102 to shift in and out of four-wheel drive. The transmission module may be used to control all wheel drive state of the vehicle.

The actuation system 106 includes a restraint control module 184. The restraint control module 184 may be configured to deploy air bags in the vehicle in response to a signal received by the controller 102. Non-limiting examples of restraint control module outputs are described in block 185. The restraint control module 184 may also deploy the air bags in the vehicle in response to impact detected by the impact crash sensor 160 independent of any control from the controller 102. The restraint control module may receive a signal from the interior occupant sensor 162. The restraint control module 184 may be configured to selectively deploy air bags in light of the passengers situated within the vehicle. For example, if the vehicle includes a driver and a passenger seated in the front row of the vehicle, the interior occupant sensor 162 may transmit a signal to the restraint control module 184 which serves to notify the restraint control module 184 of the configuration of the passengers seated within the vehicle. In the event of an accident, the restraint control module 304 may only deploy air bags used in connection with protecting the driver and the passenger in the front row of the vehicle.

The actuation system 106 includes a chassis control module 186. The chassis control module 186 may be configured to perform but not limited to anti-locking braking, selective control of braking performed on each wheel, yaw stability control, roll stability control, traction control, and suspension height adjustment, as generally described in block 187. The chassis control module 186 may receive a signal from the controller 102 in order to perform the anti-locking braking, selective control of braking, yaw stability control, roll stability control, traction control, and suspension height adjustment. The chassis control module 186 may perform the operations under control of the controller 102 or independent from the controller 102.

The actuation system 106 includes a steering wheel control module 188 for controlling the steering wheel, as generally described in block 189. The steering wheel control module 188 may be configured to turn the steering wheel shaft to a desired location in response a signal from the controller 102. In one embodiment, the steering wheel control module 188 may be implemented as part of the chassis control module 186. The chassis control module 186 may be used to conduct path correction of the vehicle, produce lateral force for mitigating roll over incidents and mitigate the motion of the vehicle after multiple vehicle contacts are made. The steering wheel control module 188 may conduct path correction by steering the vehicle to an outside of a turn in order to mitigate a roll over incident. Path correction may also be achieved through brake control. The chassis control module 186 may also allow for large suspension travel in order to mitigate the inside obstacle induced roll over.

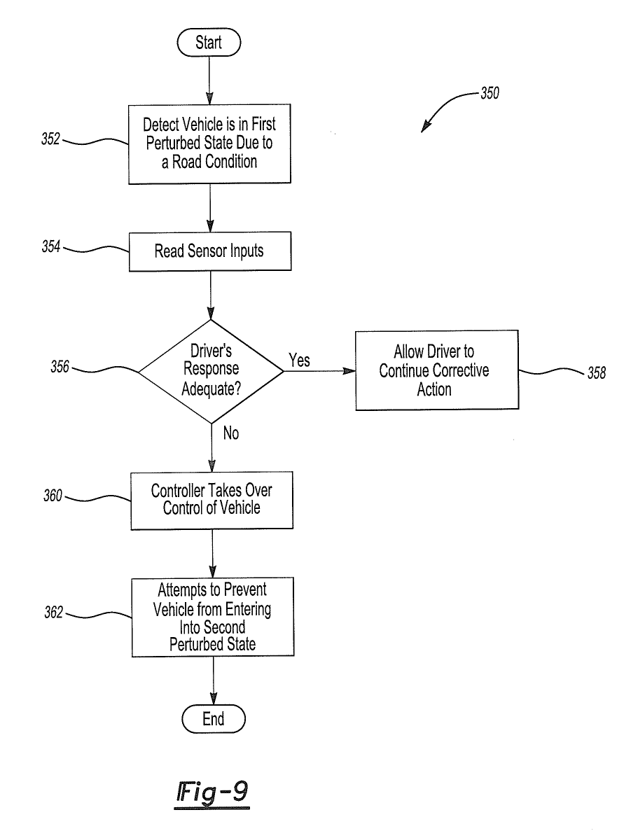

The controller 102 includes a driving perturbation state estimation module 194. The driving perturbation state estimation module 194 may use measured information, such as information measured from any of the plurality of the sensors 104 and computed information based on the sensor information to estimate current driving conditions and identify current driving perturbations experienced by the vehicle. The driving perturbation state estimation module 194 may detect when the vehicle has entered into a first perturbed state which is very different from the normal driving state. The first perturbed state will be discussed in more detail in connection with FIGS. 9-11.

The controller 102 may also include a driving perturbation state prediction module 196. The driving perturbation prediction state module 196 uses measured information as provided by the plurality of sensors 104 and computed information to predict a potential driving perturbation ahead of the vehicle. The driving perturbation prediction state module 196 may predict a potential driving perturbation ahead of the vehicle and control the vehicle in a manner to avoid the pending perturbation. The controller 102 may change various operating characteristics of the vehicle without driver intervention in order to avoid such a perturbation based on information provided by the driving perturbation state prediction module 196.

The driving perturbations experienced by the driver may include internal, external and interactive perturbations. In general, such perturbations generally include any types of incidents which impact the control of the vehicle while it is being operated by the driver that may lead to the vehicle encountering primary or secondary crashes. The perturbations experienced by the driver generally prevent the driver from effectively controlling the vehicle for an indefinite period of time.

The external perturbation may be defined as a perturbation which is a result of an external force. For example, the external perturbation may be abnormal external force that is applied to the vehicle. The abnormal external force may include abnormal sudden increases in longitudinal, lateral and vertical forces applied to one or more locations of the vehicle.

The external perturbation may include an abnormal external moment (such as a roll, a pitch or a yaw moment applied to the body of the vehicle). The abnormal external moments applied to the body of the vehicle may be due to sudden large wind gusts or external objects colliding with the vehicle. For example, external objects that collide with the vehicle may include impact from another vehicle and potential impact from run-off-road crashes. Such run-off-road crashes may include crashes between the vehicle and curbs, guardrails, trees, utility poles, culverts, signs or light posts, bridge supports, and mailboxes, or any such object that presents an external force to the vehicle at one or more locations on the vehicle.

The external perturbation may also include some form of kinetic energy transfer due to an external excitation which causes a sudden abnormal increase in kinetic energy in a certain direction. The external excitation that causes the kinetic energy transfer may be attributed to sudden abnormal changes of road geometry conditions. An example of an external kinetic energy transfer may include an off-camber road which excites the transfer of the longitudinal kinetic energy of the vehicle to the rolling energy of the vehicle.

Road geometry changes that may cause the kinetic energy of a vehicle to be transferred along the vehicle's roll direction generally include objects met while driving the vehicle off the road or onto any non-smooth driving surfaces. Such objects may include but are not limited to a soft soil surface, embankments, ditches, curbs, guardrails, and a sudden obstacle in the inside of a turn.

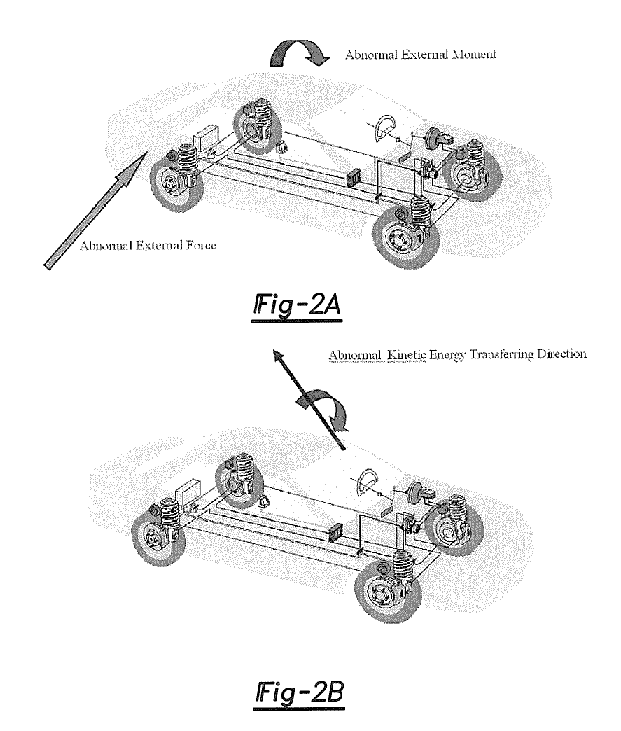

FIGS. 2a-2b generally illustrates an example of an external perturbation exerted on a vehicle. FIG. 2a illustrates the external or internal perturbation which causes abnormal force or moment variations to the vehicle that may lead to accidents. FIG. 2b illustrates abnormal kinetic energy changes that may cause accidents. For example, such a kinetic energy directional change may be due to a large road geometry variation or a sudden failure of various parts of the vehicle.

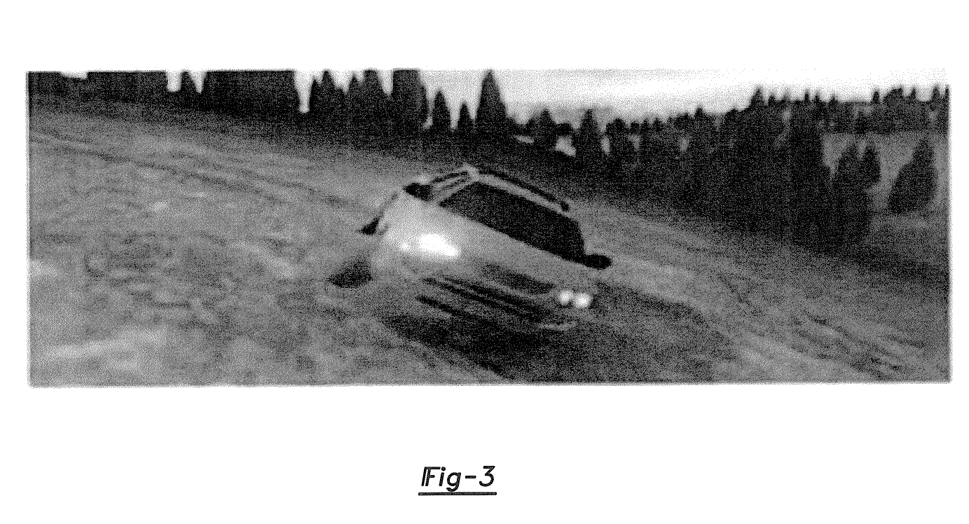

FIG. 3 is another example of an external perturbation exerted on the vehicle. In such an illustration, an external perturbation may be exerted on the vehicle due to a road geometry change. The vehicle may be driven off-camber on a mountain road which may ultimately lead to a roll over. Such a condition may be avoided by the system 100 where the controller 102 may control via the steering wheel control module 188 by steering the vehicle toward the outside of a turn in order to prevent the roll over. Such a condition may also be avoided by simultaneously applying brakes to designated wheels in order to control the speed of the vehicle while in this state. The combination of selectively applying brakes and steering may prevent a roll over in this situation.

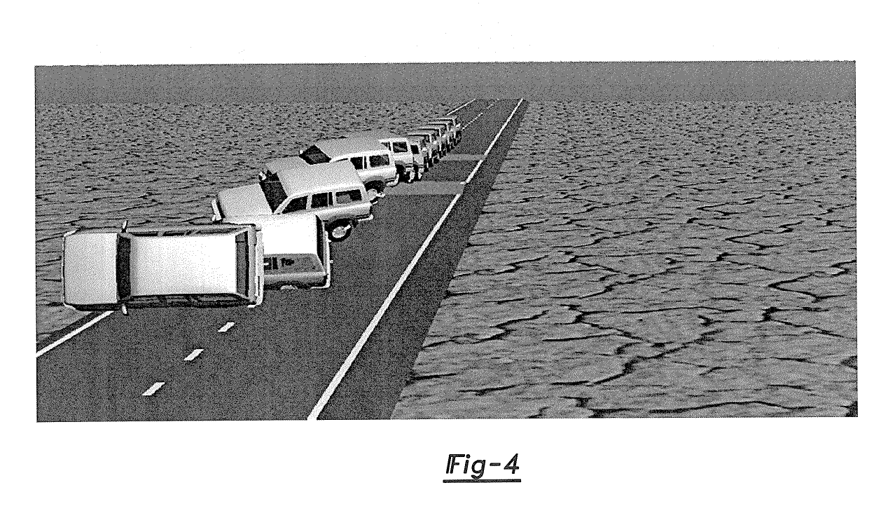

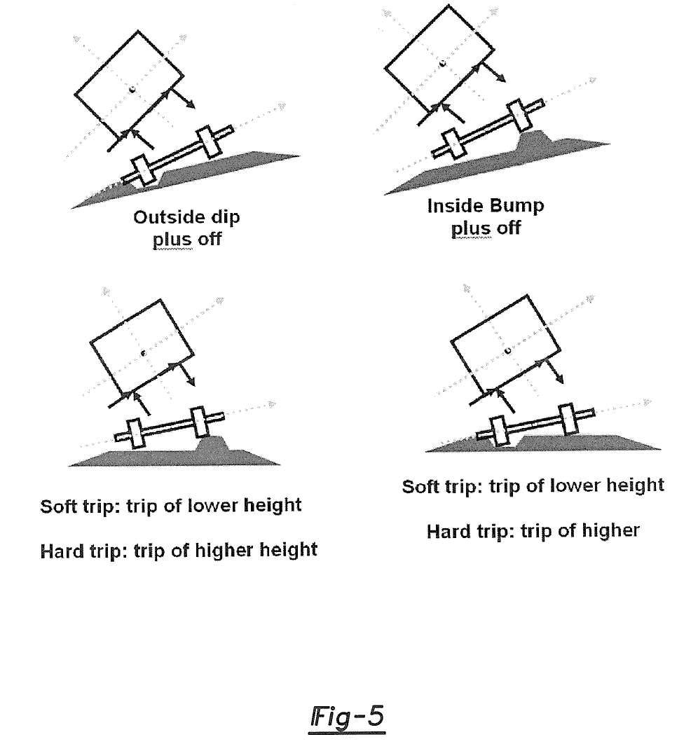

FIG. 4 generally illustrates another example of an external perturbation. In such an illustration, the collision between the vehicle and the object may lead to a roll over event. By reducing the yaw motion after the collision, the possibility of a roll over event may be reduced. FIG. 5 illustrates examples of abnormal road perturbations due to significant road geometry change in an abnormal sense.

Another type of perturbation that may be experienced by the driver of a vehicle may be the internal perturbation. The internal perturbation generally includes a sudden failure of certain parts internal to the vehicle which correspondingly leads to certain force or movement imbalance. Such examples of internal force movement or an internal perturbation may include a tire tread separation, a tire blow-out, a suspension failure and/or a brake failure. The tire tread separation may cause significant abnormality for tire longitudinal/lateral tire forces when applied from the road to the tire. In general, internal perturbations may be a perturbation in an internal kinetic energy transfer sense, such as a sudden failure of certain parts of the vehicle that generates certain directional kinetic energy transformation.

The suspension failure and the tire tread separation incident may provide for an internal kinetic energy transfer. The suspension failure and the tire tread separation incident may cause a significant and sudden vehicle height change at one corner of the vehicle that could shift the kinetic energy of the vehicle to a roll direction which could lead to a roll over.

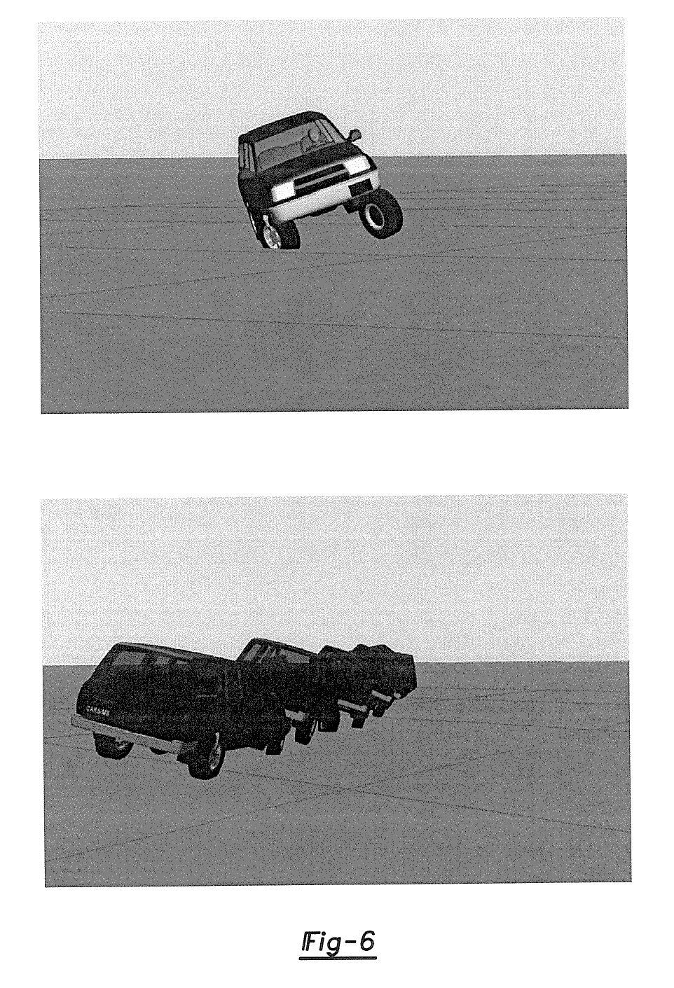

FIG. 6 generally illustrates an example of an internal perturbation. FIG. 6 illustrates a roll over event for the vehicle when a right front tire has blown out while the vehicle is performing a left turn. The system may control front steering by steering the vehicle toward the outside of the turn, cutting power to the engine and selectively applying brakes to the vehicle in order to avoid such a roll over event. In one example, a tire tread separation event may take place at the rear axle of the vehicle. Such a separation may lead to a roll over. The system 100 may selectively apply braking and/or control the steering of the vehicle in order to prevent the roll over situation.

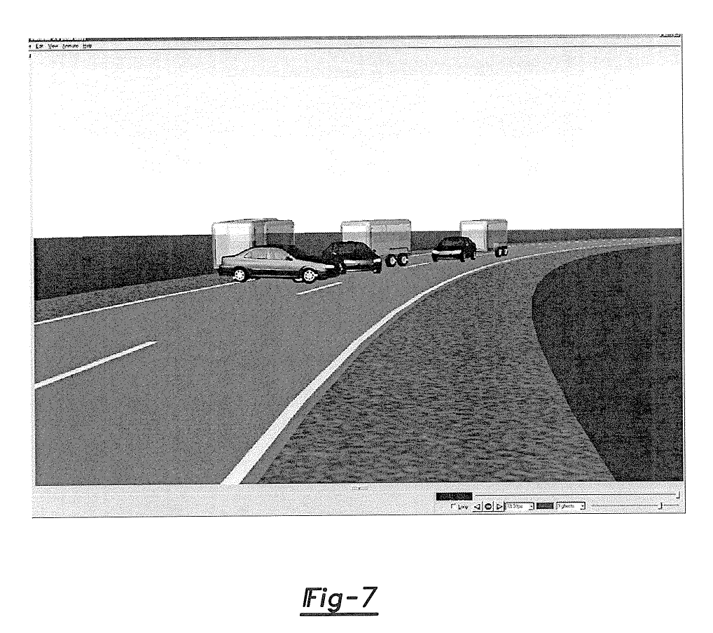

FIG. 7 generally illustrates an example of an interactive perturbation. Such a perturbation may cause sudden or significantly different vehicle behavior due to the interactive action between the different subsystem of the vehicle or between the driver and the driver-controlled vehicle dynamics. FIG. 7 illustrates a vehicle with a trailer being driven at high speeds. In such a condition, the interaction between the vehicle and the trailer may lead to a fishtail due to the driver's inexperience in handling the vehicle and the trailer at high speeds. The system 100 may selectively apply brakes, cut power to the engine and/or turn the vehicle in order to put the vehicle in a controlled state.

The interactive perturbation may be an interaction between the driver's steering, braking or throttle inputs which interactively reacts to an external or internal perturbation. In one example, an interactive perturbation may include a driver trying to steer the vehicle to correct the direction of the vehicle during a rear tire separation incident. The driver may under steer or over steer the vehicle in such a manner that may lead the vehicle into an uncontrollable state. In another example, an interactive perturbation may include a driver reacting improperly while trying to correct the direction of the vehicle during a tire blowout. In another example, an interactive perturbation may involve the case in which a car is trailering an object and the combined vehicle dynamics between the car and the object creates a situation in which the driver incorrectly directs the vehicle while reacting to the vehicle dynamics between the vehicle and the object. In another example, an interactive perturbation may involve the case in which a driver encounters a large road geometry change which causes an unfamiliar driving condition for the driver. Such an unfamiliar driving condition may cause a safety hazard when the driver reacts in a wrong way. Examples of road geometry changes may include but are not limited to a sudden narrow roadway or bridge, a work zone, a road with various design limitations, railroad crossings, and a sudden tight turn needed to reduce speed.

The controller 102 may control one or more modules in the actuation system 106 with actuation commands in response to estimated or predicted driving perturbations that may be experienced by the driver. In response to the actuation commands, the one or more modules in the actuation system 106 may change various operating characteristics of the vehicle in order to avoid such perturbations.

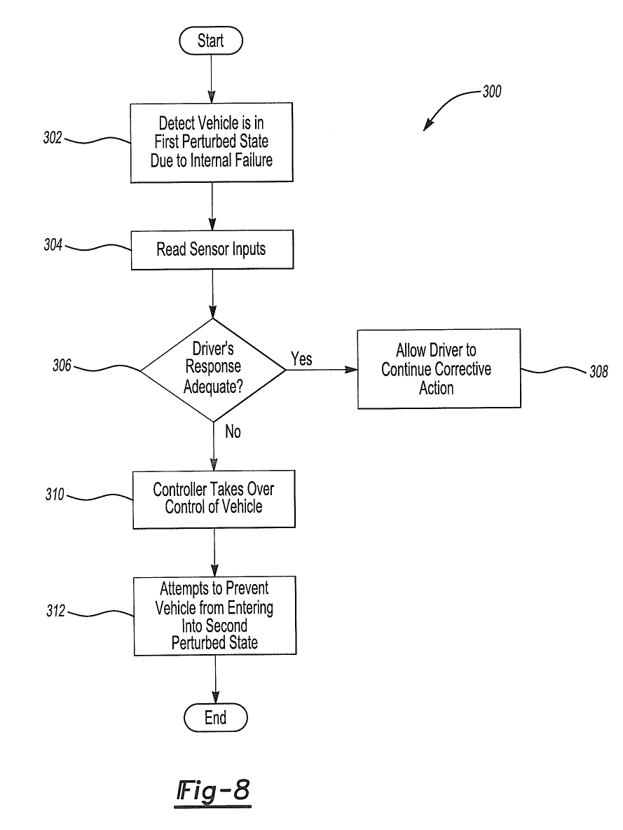

FIG. 8 illustrates a flow diagram 300 for detecting a first perturbed state due to an internal failure in the vehicle and preventing a vehicle from entering into a second perturbed state. The diagram 300 generally illustrates one example for detecting a first perturbed state due to an internal failure in the vehicle and for preventing a second perturbed state from occurring. In step 302, the system 100 detects that the vehicle is in a first perturbed state involving an internal failure associated with the vehicle. Such an internal failure may be attributed to a tire failure or a chassis failure. In the case of a tire blow-out, the tire pressure sensor 150 may detect a dramatic decrease in pressure in relation to any one or more tires of the vehicle or the wheel speed sensor 156 will detect a sudden change in an output of the wheel speed sensor 156. The tire pressure sensor 150 may send information which corresponds to which tire had suffered a separation to the controller 102. In the case of a suspension failure, the suspension height sensor 152 may detect a corresponding abnormal suspension behavior which is associated with the failure on the vehicle. The suspension height sensor 152 may detect which suspension component in the vehicle suffered such a failure. When the vehicle has suffered an internal failure due to a tire failure or a chassis failure, such information is transmitted to the driving perturbation state estimation module 194. The driving perturbation state estimation module 194 determines that the vehicle is in a first perturbed state and the driver may not have total control of the vehicle. In general, the system 100 may try to avoid entry into a second perturbed state. If the second perturbed state cannot be totally avoided, the system 100 may try to mitigate the effect of the second perturbed state. The second perturbed state may include a collision between the vehicle and an object or a potential roll over.

In step 304, the controller 102 may read inputs from the plurality of sensors 104 while the vehicle is in the first perturbed state. The controller 102 may continue to read inputs from the tire pressure sensor 150 and the suspension height sensor 152. The controller 102 may also read inputs from the IMU sensing unit 164 to assess the roll rate, yaw rate, pitch rate, longitudinal acceleration, lateral acceleration and vertical acceleration while the vehicle is experiencing an internal failure (the first perturbed state). The controller 102 may also continue to read inputs from the radar/lidar sensor 170 and the vision sensor 172 after the vehicle has been placed in the first perturbed state. The driving perturbation state prediction module 196 may determine if the vehicle is going to enter into the second perturbed state in response to reading the inputs.

In step 306, the controller 102 may determine whether the driver's response on the inputs received by the plurality of sensor 104 is adequate to prevent the loss of control or other unsafe condition. For example, the controller 102 may determine if the current speed of the vehicle and the direction of the vehicle will lead to a corrective and safe path if left in the control of the driver. If the controller 102 determines that the driver's response is adequate, then diagram 300 will move to step 308.

In step 308, the controller 102 may allow the driver to control the vehicle. In step 312, the driver's corrective action will allow the vehicle to avoid the second perturbed state. The second perturbed state may include a collision with one or more objects in response to the vehicle being in the first perturbed state or a rollover event.

In step 306, if the controller 102 (via the driving perturbation state prediction module 196) determines that the driver's response is inadequate to prevent the loss of control or the other unsafe condition based on the inputs received by plurality of sensors 104, then diagram 300 moves to step 310. In step 310, the controller 102 may intervene on behalf of the driver and employ countermeasures to prevent the vehicle from entering into the second perturbed state. In a first countermeasure, the controller 102 may control the steering wheel control module 188 to adjust the direction of the vehicle. In a second countermeasure, the controller 102 may control the powertrain control module 182 to either increase or decrease the speed of the vehicle (or cut power to the engine) in order to reach the desired corrective and safe path. The controller 102 may also control the powertrain control module 182 such that the powertrain control module 182 controls a differential to achieve a corrective and safe path. In a third countermeasure, the controller 102 may control the chassis control module 186 to selectively apply the brakes in order to decrease the speed of the vehicle in certain directions and straighten the vehicle out, or the chassis control module 186 may adjust the height of the suspension to level the height of the vehicle in the case of a suspension failure. In a fourth countermeasure, the controller 102 may control the restraint control module 184 to pre-arm corresponding air-bags in the vehicle to be ready for deployment in the event a collision could not be avoided.

In step 312, the vehicle may be prevented from entering into the second perturbed state in response to the controller 102 employing one or more of the first, second, third and fourth countermeasures. For example, the controller 102 may employ any combination of the first, second, third, and fourth countermeasures to avoid a roll over in response to the initial tire tread separation or the suspension failure detected by the system 100. The controller 102 may also employ one or more of the first, second, third and fourth countermeasures if it is not possible for the vehicle to avoid a collision after the tire separation and/or the chassis separation. For example, the controller 102 may position the vehicle and adjust the vehicle in such a configuration to allow the vehicle to experience a minimal amount of damage and the driver to suffer a minimal amount of injury in a collision after the tire separation and/or suspension failure.

FIG. 9 illustrates a flow diagram 350 for detecting a first perturbed state due to road condition and preventing a vehicle from entering into a second perturbed state. Such road conditions may include but are not limited to the vehicle encountering a soft soil surface, an embankment, a ditch, a curb, a guardrail, and a sudden obstacle in the inside of a turn. If the vehicle encounters any of the road conditions, the vehicle may be in a first perturbed state. The second perturbed state may correspond to an ensuing roll over or collision with another object due to the road condition. The system 100 may prevent the vehicle from entering into the second perturbed state or minimize the impact to the driver and the vehicle in the event it is not possible for the vehicle to avoid entering into the second perturbed state. The diagram 350 generally illustrates one example for detecting a first perturbed state due to road condition and preventing the vehicle from entering a second perturbed state.

In step 352, the system 100 detects that the vehicle is in a first perturbed state involving a road condition. The road condition may involve any one of the scenarios described above. In the case the road condition involved a ditch and the vehicle hit the ditch, the controller 102 may read inputs from the IMU sensing unit 164 to assess the roll rate, yaw rate, pitch rate, longitudinal acceleration, lateral acceleration and vertical acceleration of the vehicle to determine if the vehicle is in a first perturbed state. If the signals from the IMU sensing unit 164 indicate that the vehicle may be experiencing an abnormal external roll, pitch and yaw moment, the controller (via the driving perturbation state estimation module 194) detects that the vehicle is in the first perturbed state.

In step 354, the controller 102 may read inputs from the plurality of sensors 104 while the vehicle is in the first perturbed state. The controller 102 may continue to read inputs from the IMU sensing unit 164 to assess the roll rate, yaw rate, pitch rate, longitudinal acceleration, lateral acceleration and vertical acceleration after the vehicle has been placed in the first perturbed state. The controller 102 may also continue to read inputs from the radar/lidar sensor 170 and the vision sensor 172 after the vehicle has been placed in the first perturbed state. The driving perturbation prediction module 196 may determine if the vehicle enters into the second perturbed state in response to the readings of the inputs when the vehicle is in the first perturbation state.

In step 356, the controller 102 may determine whether the driver's response based on the inputs received from the IMU sensing unit 164 and/or the radar/lidar sensor 170 and the vision sensor 172 are adequate to prevent the loss of control or other unsafe condition. For example, the controller 102 may determine if the current speed of the vehicle and the direction of the vehicle will lead to a corrective path if left in the control of the driver. If the controller 102 determines that the driver's response is adequate, then diagram 300 will move to step 358.

In step 358, the controller 102 may allow the driver to resume control over the vehicle. In step 362, the driver's corrective action will allow the vehicle to avoid a collision or a roll over event. In step 356, if the controller 102 determines that the driver's response is inadequate based on the inputs received by the IMU sensing unit 164 and/or the radar/lidar sensor 170 and the vision sensor 172, then diagram 300 moves to step 310. In step 310, the controller 102 may intervene on behalf of the driver and employ countermeasures to prevent the vehicle from entering into the second perturbed state. In a first countermeasure, the controller 102 may control the steering wheel control module 188 to adjust the direction of the vehicle. In a second countermeasure, the controller 102 may control the powertrain control module 182 to either increase or decrease the speed of the vehicle (or cut power to the engine) in order to reach the desired corrective and safe path. The controller 102 may also control the powertrain control module 182 such that the powertrain control module 182 controls a differential to achieve a corrected and safe path. In a third countermeasure, the controller 102 may control the chassis control module 186 to selectively apply the brakes in order to decrease the speed of the vehicle in certain directions and straighten the vehicle out to prevent a roll over. In a fourth countermeasure, the controller 102 may control the restraint control module 184 to pre-arm air-bags in the vehicle to be ready for deployment in the event a collision could not be avoided.

In step 362, the vehicle may be prevented from entering into the second perturbed state in response to the controller 102 employing one or more of the first, second, third and fourth countermeasures. For example, the controller 102 may employ one or more of the first, second, third, and fourth countermeasures to avoid a roll over event or a collision in response to the road condition which lead to the vehicle being in the first perturbed state. For example, the controller 102 may position the vehicle and adjust the vehicle in such a configuration to allow the vehicle to experience a minimal amount of damage and the driver to suffer a minimal amount of injury in the event the collision could not be avoided.

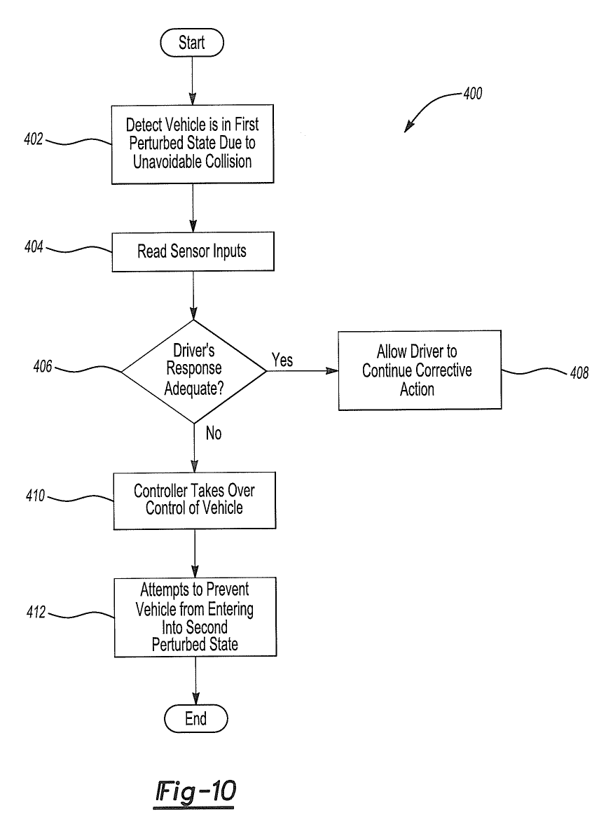

FIG. 10 illustrates a flow diagram 400 for detecting a first perturbed state due to a primary collision and preventing the vehicle from entering into a second perturbed state. The vehicle may enter into the first perturbed state as a result of being unable to avoid a primary collision. The vehicle may enter into the second perturbed state which may include a secondary collision or roll over after the vehicle was engaged in the primary collision. The system 100 may prevent the vehicle from entering into the second perturbed state or minimize the impact to the driver and the vehicle if it is not possible for the vehicle to avoid entering into the second perturbed state.

The diagram 400 generally illustrates one example for detecting a first perturbed state and preventing the second perturbed state. In step 402, the system 100 detects that the vehicle is in the first perturbed state or has encountered a primary collision that was unavoidable. The controller 102 (via the driving perturbation state estimation module 194) will determine that the vehicle has been engaged in a primary collision by reading inputs from the radar/lidar sensor 170, the vision sensor 172, and the impact crash sensor 160. The restraint control module 184 may deploy the corresponding air bags in the vehicle which coincide to the areas of the vehicle impacted by the collision.

In step 404, the controller 102 may read inputs from the plurality of sensors 104 while the vehicle is in the first perturbed state. The controller 102 may continue to read inputs from the radar/lidar sensor 170, the vision sensor 172, and the impact crash sensor 160 after the vehicle has been placed in the first perturbed state. The controller 102 may also continue to read inputs from the IMU sensing unit 164 to assess the roll rate, yaw rate, pitch rate, longitudinal acceleration, lateral acceleration and vertical acceleration after the vehicle has been placed in the first perturbed state. The driving perturbation state module 196 may determine if the vehicle enters into the second perturbed state in response to reading the inputs.

In step 406, the controller 102 may determine whether the driver's response based on the inputs received from the IMU sensing unit 164 and/or the radar/lidar sensor 170 and the vision sensor 172 are adequate to prevent the loss of control or the other unsafe condition. For example, the controller 102 may determine if the current speed of the vehicle and the direction of the vehicle will lead to a corrective path if left in the control of the driver. If the controller 102 determines that the driver's response is adequate, then diagram 400 will move to step 408.

In step 408, the controller 102 may allow the driver to have control over the vehicle. In step 412, the driver's corrective action will allow the vehicle to avoid a secondary collision or roll over event. In step 406, if the controller 102 determines that the driver's response is inadequate based on the inputs received by the IMU sensing unit 164, the radar/lidar sensor 170 and/or the vision sensor 172, then diagram 400 moves to step 412. In step 412, the controller 102 may intervene on behalf of the driver and employ countermeasures to prevent the vehicle from entering into the second perturbed state (e.g., secondary collision or roll over event). In a first countermeasure, the controller 102 may control the steering wheel control module 188 to adjust the direction of the vehicle. In a second countermeasure, the controller 102 may control the powertrain control module 182 to either increase or decrease the speed of the vehicle (or cut power to the engine) in order to reach the desired corrective and safe path and control the differential to achieve a corrective path in order to avoid a roll over event. In a third countermeasure, the controller 102 may control the chassis control module 186 to selectively apply the brakes in order to decrease the speed of the vehicle in certain directions and straighten the vehicle out to prevent a roll over. In a fourth countermeasure, the controller 102 may control the restraint control module 184 to pre-arm corresponding air-bags in the vehicle to be ready for deployment in the event the secondary collision could not be avoided.

In step 412, the vehicle may be prevented from entering into the second perturbed state in response to the controller 102 employing one or more of the first, second, third and fourth countermeasures. For example, the controller 102 may employ one or more of the first, second, third, and fourth countermeasures to avoid a secondary collision or a roll over. The controller 102 may also employ any combination of the first, second, third and fourth countermeasures if it is not possible for the vehicle to avoid the secondary collision. For example, the controller 102 may position the vehicle and adjust the vehicle in such a configuration to allow the vehicle to experience a minimal amount of damage and the driver to suffer a minimal amount of injury in the secondary collision.

In general, the system 100 is configured to extend the operation range over conventional safety systems to a range including single vehicle accidents and multiple vehicle accidents. That is, the system 100 is configured to detect the safety threat to the vehicle and prevent single vehicle and/or multiple vehicle accidents. The system 100 controls the vehicle in such a manner to reduce the severity of unavoidable crashes and mitigates any potential secondary collisions that may occur after a primary collision has occurred. The system 100 is configured to detect when the vehicle is in a state of duress due to road conditions, internal failures associated with the vehicle or when the vehicle has encountered a collision. If it is not possible to avoid an ensuing collision after the vehicle is in an initial state of duress, the system 100 may be configured to control the post-collision motion of the vehicle such that any potential damage to the vehicle may be minimized.

While the best mode for carrying out the invention has been described in detail, those familiar with the art to which this invention relates will recognize various alternative designs and embodiments for practicing the invention as defined by the following claims.

What is claimed:

1. An active safety control system for a driver of a vehicle when the vehicle is in a first perturbed state, the system comprising:
a plurality of sensors operable to generate signals which indicate that the vehicle is in the first perturbed state;
an actuation system adapted to change driving conditions of the vehicle; and
a controller configured to selectively control the actuation system in response to the signals without driver intervention to change the driving conditions of the vehicle to regain control of the vehicle after the vehicle has entered the first perturbed state.

2. The active safety control system of claim 1, wherein the actuation system includes a power train control module and the controller is further configured to control the power train control module to change the driving conditions of the vehicle by controlling the speed of the vehicle.

3. The active safety control system of claim 1, wherein the controller is further configured to control the power train control module to change the driving conditions of the vehicle by controlling a differential to bias the path of the vehicle.

4. The active safety control system of claim 1, wherein the actuation system includes a chassis control module and the controller is further configured to control the chassis control module to change the driving conditions to reduce the speed of the vehicle by selectively applying brakes to wheels of the vehicle.

5. The active safety control system of claim 4, wherein the controller is further configured to control the chassis control module to allow a predetermined amount of suspension travel or damping.

6. The active safety control system of claim 1, wherein the controller is configured to selectively control the actuation system to regain control of the vehicle such that the vehicle does not enter into a second perturbed state, wherein the second perturbed state occurs after termination of the first perturbed state.

7. The active safety control system of claim 6, wherein the first perturbed state corresponds to an internal failure associated with the vehicle while in motion which causes the driver to lose control of the vehicle and the second perturbed state corresponds to one of a pending collision between the vehicle and one or more objects due to the internal failure and a pending roll over event.

8. The active safety control system of claim 6, wherein the internal failure associated with the vehicle corresponds to a tire failure such as a tire blow-out or a tire tread separation.

9. The active safety control system of claim 6, wherein the first perturbed state corresponds to a change in the road conditions which causes the driver to lose control of the vehicle and the second perturbed state corresponds to one of a pending collision between the vehicle and one or more objects and a pending roll over event.

10. The active safety control system of claim 6, wherein the first perturbed state corresponds to a primary collision between the vehicle and an object and the second perturbed state corresponds to one of a pending secondary collision between the vehicle and one or more objects and a pending roll over event.

11. The safety control system of claim 6, wherein the actuation system includes a restraint control module and the controller is further configured to control the restraint control module to pre-activate air bags prior to the vehicle entering into the second perturbed state if it is not possible for the vehicle to avoid entering into the second perturbed state when changing the driving conditions of the vehicle.

12. A method for providing an active safety control system for a driver of a vehicle, the method comprising:
determining whether the vehicle has entered into a first perturbed state resulting in the driver losing control of the vehicle; and
selectively changing driving conditions of the vehicle to regain control of the vehicle after the vehicle has entered into the first perturbed state to redirect the vehicle in such a manner to prevent the vehicle from entering into a second perturbed state or to minimize injury to the driver and damage to the vehicle in the event the second perturbed state is unavoidable.

13. The method of claim 12, further comprising controlling the speed of the vehicle to regain control of the vehicle.

14. The method of claim 12, further comprising controlling a differential to bias the path of the vehicle to regain control of the vehicle.

15. The method of claim 12, further comprising reducing the speed of the vehicle by selectively applying brakes to wheels of the vehicle to regain control of the vehicle.

16. The method of claim 12, further comprising pre-arming air bags on the vehicles prior to the secondary collision in the event the secondary collision is unavoidable.

17. The method of claim 12, further comprising controlling one of a steering wheel and brake controls of the vehicle to change vehicle direction to regain control of the vehicle and to move the vehicle into a safe path.

18. An active safety control system for a driver of a vehicle, the system comprising:
a plurality of sensors operable to generate signals which indicate that the driver has lost control of the vehicle in response to one of an internal failure in the vehicle, a road condition, and a primary collision with one or more objects;
an actuation system adapted to change driving conditions of the vehicle; and
a controller configured to selectively control the actuation system without driver intervention to change the driving conditions of the vehicle to regain control of the vehicle in response to the signals such that the vehicle avoids one of a roll over event and a secondary collision with additional objects or minimizes the impact to the driver and the vehicle in the event the secondary collision is unavoidable.

19. The active safety control system of claim 18, wherein the controller is further configured to position the vehicle in such a manner while regaining control of the vehicle to minimize the danger presented to the driver in the event the secondary collision is unavoidable.

20. The active safety control system of claim 18, wherein the controller is further configured to control the speed of the vehicle while regaining control of the vehicle in order to minimize the impact to the driver in the event the secondary collision is unavoidable.
